(19) United States
(12) Patent Application Publication
(10) Pub. No.: US 2012/0084638 A1
(43) Pub. Date: Apr. 5, 2012

(54) TECHNIQUES CONTENT MODIFICATION IN AN ENVIRONMENT THAT SUPPORTS DYNAMIC CONTENT SERVING

(75) Inventors: PHIL N. CALVIN, San Francisco, CA (US); BRIAN ZOTTER, Danville, CA (US); ERIC G. DORGELO, Vancouver (CA)

(73) Assignee: SALESFORCE.COM, INC., San Francisco, CA (US)

(21) Appl. No.: 13/310,525

(22) Filed: Dec. 2, 2011

Related U.S. Application Data
(63) Continuation-in-part of application No. 12/935,890, filed on Sep. 30, 2010.
(60) Provisional application No. 61/419,611, filed on Dec. 3, 2010.

(51) Int. Cl. G06F 17/24

(52) U.S. Cl. 715/234

(57) ABSTRACT

Methods and apparatuses for collaboratively editing page content. Instances of classes are stored in a central repository, wherein the classes correspond to components of a page. Concurrent user access to the classes is provided. The page is updated in response to modifications to the page content made utilizing the one or more class instances.

### CLAIM OF PRIORITY

This application claims the benefit of U.S. Provisional Patent Application 31/419,611, entitled “A CONTENT MANAGEMENT SYSTEM FOR DEVELOPING AND INTERACTING WITH WEB SITES,” by Philip Calvin, et al., filed Dec. 3, 2010, the entire contents of which is incorporated herein by reference.

This application is a continuation-in-part of U.S. patent application Ser. No. 12/935,890, entitled “OBJECT-ORIENTED SYSTEM FOR CREATING AND MANAGING WEB SITES AND THEIR CONTENT,” by Philip Calvin, filed Sep. 30, 2010, the entire contents of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments relate to techniques for providing metadata-driven content. More particularly, embodiments relate to techniques for modifying content in an environment that supports use of multiple servers to provide metadata-driven dynamic content.

### BACKGROUND

Servers that provide content in the form of pages to requesting devices generally cannot provide constant uptime availability. This may be the result of various conditions including routine maintenance operations, system upgrades, content changes, etc. This is a less than optimal situation for providing content.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram of one embodiment of web site classes that may be utilized to provide a multi-user, modular architecture that can be used for creating and managing components of a web site and content over the entire life cycle.

FIG. 2 is a logical diagram of one embodiment of page development as described herein.

FIG. 3 illustrates a block diagram of an example of an environment wherein an on-demand database service might be used.

FIG. 4 illustrates a block diagram of an embodiment of elements of FIG. 3 and various possible interconnections between these elements.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

Building dynamic, data-driven web sites and then managing the content within hem is typically a sequential process involving multiple people with different skill sets, systems and tools. Thus, using traditional tools the final data-driven web site is not ready for use or testing until several steps are completed, in a specific order, involving multiple people. This leads to inefficiencies and increased costs.

Using traditional techniques and assuming that the database, content management and web servers are set up, starting with a completed functional requirements and graphic design elements for the web site as inputs, the following steps are required to get a live web site running with a content management system (CMS). First, a web page is built using, for example, HyperText Markup Language (HTML) and cascading style sheets (CSS), using graphic design elements as inputs. Second, each of the web pages is converted to page templates in the CMS. This typically involves importing the files and adding CMS-specific Extensible Markup Language (XML) tags to the HTML files to denote the elements of each page that will be dynamically controlled by the CMS.

Third, for each page that requires content from an external database, a data access mechanism is developed. This typically involves writing appropriate queries, exposing the required queries/views to the CMS, developing data-driven web page elements in the CMS that interface with the exposed data, and creating additional page templates in the CMS that use these elements. Fourth, the actual content pages are built. This can be done by less technical editors than the previous steps, for example, using a WYSIWYG type editing tool for regions of the page that can be edited.

Fifth, testing and debug operations are performed and the final product may be deployed to the servers. For each change to the content the fourth through sixth steps are repeated. If new page templates are required or changes to existing templates are needed, all of the steps are repeated with the possible exception of the third. The steps listed above can result in a complex and time-consuming process to modify a web site.

Described herein are various embodiments of a multi-user, modular architecture that can be used for creating and managing components of a web site and content over the entire life cycle (e.g., from initial development through testing, publishing and updating of design and/or content). Thus, multiple concurrent users can create, read, update and delete (CRUD) components of the web site separately from other uses an in different orders. This may allow a team to collaborate and work on the web site in a way that is not possible with the traditional techniques described above.

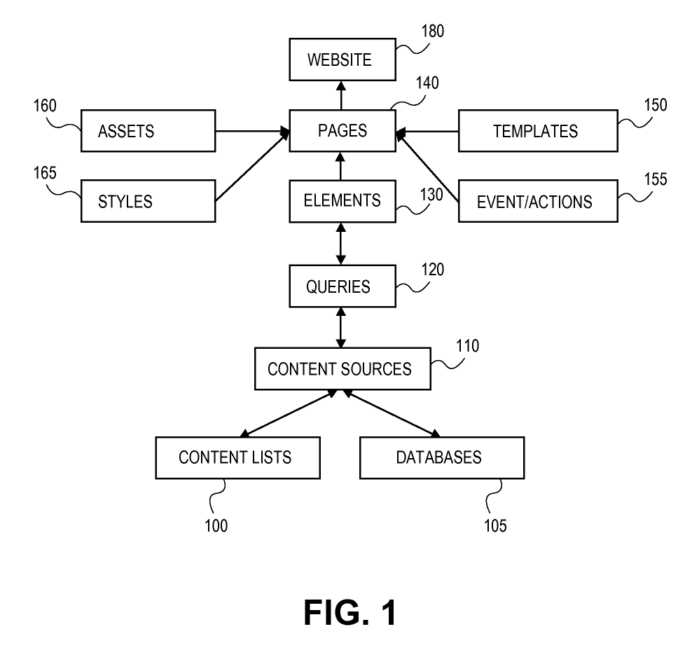

FIG. 1 is a block diagram of one embodiment of web site classes that may be utilized to provide a multi-user, modular architecture that can be used for creating and managing components of a web site and content over the entire life cycle. Using the classes illustrated in FIG. 1, a user may, for example, create, read, update or delete (CRUD) content items while another user may CRUD assets, styles, page templates or dynamic page elements that will be use to display the content according to the web site visual design standards. Another user can configure new content sources and types. In one embodiment, the system dynamically assembles these elements and publishes them as dynamic, data-driven web pages within the web site.

In one embodiment, specific instances of the classes (i.e., the objects an their bindings to each other within a specific web site) are stored in a central repository with fine-grained, concurrent user access control that allows the development, testing and publishing of the components by individual users or teams of users. Various embodiments make it possible to make fundamental web site design changes at any time. For example, changing the way content is displayed on all pages of a web site (e.g., using three columns instead of two columns, or adding tree views to display hierarchical data relationships). This can be done by updating page templates and page elements. Once updated, any pages using these components may automatically update to reflect the newer design and all other elements within the site, for example, content and style definitions, may remain unchanged.

Content lists 100 and databases 105 represent sources of data that may be utilized by content sources 110. Content sources 110 represent one or more sources of content that may be utilized to provide web site 180. Queries 120 represent the queries that may be utilized to acquire information/content from content sources 110. Elements 130 represent the elements of web site 180 and/or pages 140 that may utilize queries to acquire content.

Web site 180 may include multiple pages 140, each of which may include one or more classes corresponding to one or more of assets 160, styles 165, templates 150 and/or events/actions 155. Pages 140 are constructed using assets 160, styles 165, templates 150 and/or events/actions 155. In one embodiment, pages 140 are dynamic and data-driven. Pages 140 are utilized to provide web page 180.

As described above, each of templates 150, events/actions 155, assets 160 and/or styles 165 may be independently accessed and/or modified to result in changes/updates to pages 140, which provide corresponding changes/updates to web site 180.

Many web sites are dynamic and driven by data of some sort that allows the user/visitor to input, search, sort and/or view information stored in data objects within a database or web service. However, traditional web page developers that are trained for designing and building the graphical/visual elements of a web site may not possess the technical skills to access and process data for a data-driven web site. These technical skills include understanding Asynchronous JavaScript and XML (AJAX) design patters, as well as Structured Query Language (SQL) and XML web service programming, PHP, and other server-side technologies.

Architectures described herein can abstract the programming details of creating, querying, reading, updating or deleting data items contained within any data source from the pages and page elements that use them. Data sources can be any software system that can return structured data to a caller via a REST-based API. Examples include salesforce.com data objects, business-specific databases, content lists, RSS feeds, Flikr photo lists and Facebook or Twitter feeds. In one embodiment, a unique data source connector is provided for each unique data source type that is accessible from the pages.

This allows page developers that are not back end programmers to build data-driven content and web pages and focus on the visual representation of, and interaction with, data on the pages, rather than the programming details of accessing the data and searching, sorting or filtering it. Also, the developer may be shielded from the details of ensuring that data is accessed in a secure, reliable and robust manner.

Instead of programming, the techniques described herein allow the page developer to configure which data sources are needed and which queries may be used to filter and sort the data that is available from the data source. In one embodiment, once this is done, the page developer visually binds the data elements to the web page elements.

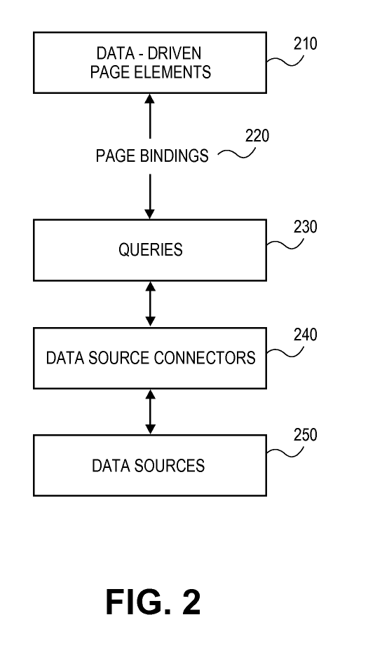

FIG. 2 is a logical diagram of one embodiment of page development as described herein. Using these techniques, the web developer only needs to configure which data sources they wish to use and the queries that use them via, for example, a fill-in-the-blanks query builder. Once queries have been defined, the page developer can bind 220 each field returned from a query 230 to an individual page element 210.

For example, the name, price, picture and description fields returned from a products data source 250 through data source connectors 240 can be bound to three content blocks and an image object on a page. This defines how each record from the data source is bound to the page. With style and page elements, the page is completed. This can be performed for each item returned form the data source. (e.g., a list of products).

In one embodiment, the development techniques described above are utilized within a multitenant environment. The techniques may be used for development of pages to be used by one or more tenants of the multitenant environment.

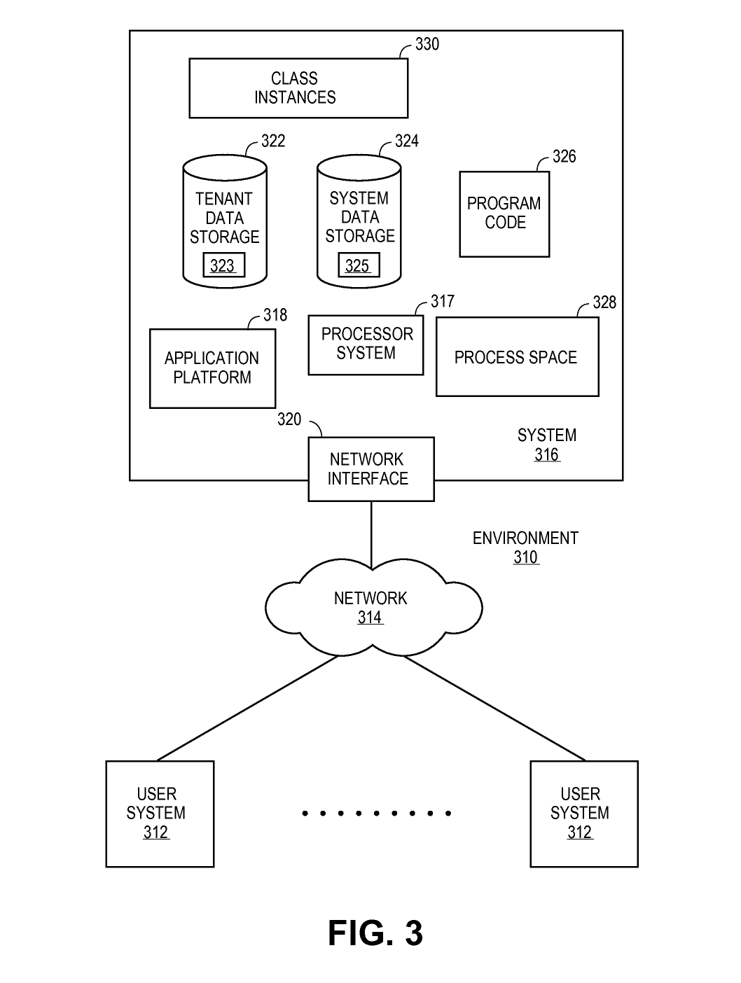

FIG. 3 illustrates a block diagram of an environment 310 wherein an on-demand database service might be used. Environment 310 may include user systems 312, network 314, system 316, processor system 317, application platform 318, network interface 320, tenant data storage 322, system data storage 324, program code 326, process space 328 and class instances 330. In other embodiments, environment 310 may not have all of the components listed and/or may have other elements instead of, or in addition to, those listed above.

Environment 310 is an environment in which an on-demand database service exists. User system 312 may be any machine or system that is used by a user to access a database user system. For example, any of user systems 312 can be a handheld computing device, a mobile phone, a laptop computer, a work station, and/or a network of computing devices. As illustrated in FIG. 3 (and in more detail in FIG. 3) user systems 312 might interact via a network 314 with an on-demand database service, which is system 316.

An on-demand database service, such as system 316, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 316” and “system 316” will be used interchangeably herein.

A database image may include one or more database objects. A relational database management system (RDMS) or the equivalent may execute storage and retrieval of information against the database object(s). Application platform 318 may be a framework that allows the applications of system 316 to run, such as the hardware and/or software, e.g., the operating system. In an embodiment, on-demand database service 316 may include an application platform 318 that enables creation, managing and executing one or more applications developed by the provider of the on-demand database service, users accessing the on-demand database service via user systems 312, or third party application developers accessing the on-demand database service via user systems 312.

The users of user systems 312 may differ in their respective capacities, and the capacity of a particular user system 312 might be entirely determined by permissions (permission levels) for the current user. For example, where a salesperson is using a particular user system 312 to interact with system 316, that user system has the capacities allotted to that salesperson. However, while an administrator is using that user system to interact with system 316, that user system has the capacities allotted to that administrator.

In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 314 is any network or combination of networks of devices that communicate with one another. For example, network 314 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited, although TCP/IP is a frequently implemented protocol.

User systems 312 might communicate with system 316 using TCP/IP and, at a higher network level, use other common Internet protocols to communicate, such as HTTP, FTP, AFS, WAP, etc. In an example where HTTP is used, user system 312 might include an HTTP client commonly referred to as a “browser” for sending and receiving HTTP messages to and from an HTTP server at system 316. Such an HTTP server might be implemented as the sole network interface between system 316 and network 314, but other techniques might be used as well or instead. In some implementations, the interface between system 316 and network 314 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 316, shown in FIG. 3, implements a web-based customer relationship management (CRM) system. For example, in one embodiment, system 316 includes application servers configured to implement and execute CRM software applications as well as provide related data, code, forms, webpages and other information to and from user systems 312 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared.

In certain embodiments, system 316 implements applications other than, or in addition to, a CRM application. For example, system 316 may provide tenant access to multiple hosted (standard and custom) applications, including a CRM application. User (or third party developer) applications, which may or may not include CRM, may be supported by the application platform 318, which manages creation, storage of the applications into one or more database objects and executing of the applications in a virtual machine in the process space of the system 316.

One arrangement for elements of system 316 is shown in FIG. 3, including a network interface 320, application platform 318, tenant data storage 322 for tenant data 323, system data storage 324 for system data 325 accessible to system 316 and possibly multiple tenants, program code 326 for implementing various functions of system 316, and a process space 328 for executing MTS system processes and tenant-specific processes, such as running applications as part of an application hosting service. Additional processes that may execute on system 316 include database indexing processes.

Several elements in the system shown in FIG. 3 include conventional, well-known elements that are explained only briefly here. For example, each user system 312 could include a desktop personal computer, workstation, laptop, PDA, cell phone, or any wireless access protocol (WAP) enabled device or any other computing device capable of interfacing directly or indirectly to the Internet or other network connection. User system 312 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 312 to access, process and view information, pages and applications available to it from system 316 over network 314.

Each user system 312 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 316 or other systems or servers. For example, the user interface device can be used to access data and applications hosted by system 316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 312 and all of its components are operator configurable using applications, such as a browser, including computer code run using a central processing unit such as an Intel Pentium® processor or the like. Similarly, system 316 (and additional instances of an MTS, where more than one is present) and all of their components might be operator configurable using application(s) including computer code to run using a central processing unit such as processor system 317, which may include an Intel Pentium® processor or the like, and/or multiple processor units.

A computer program product embodiment includes a machine-readable storage medium (media) having instructions stored thereon/in which can be used to program a computer to perform any of the processes of the embodiments described herein. Computer code for operating and configuring system 316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data.

Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 316 is configured to provide webpages, forms, applications, data and media content to user (client) systems 312 to support the access by user systems 312 as tenants of system 316. As such, system 316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B).

As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

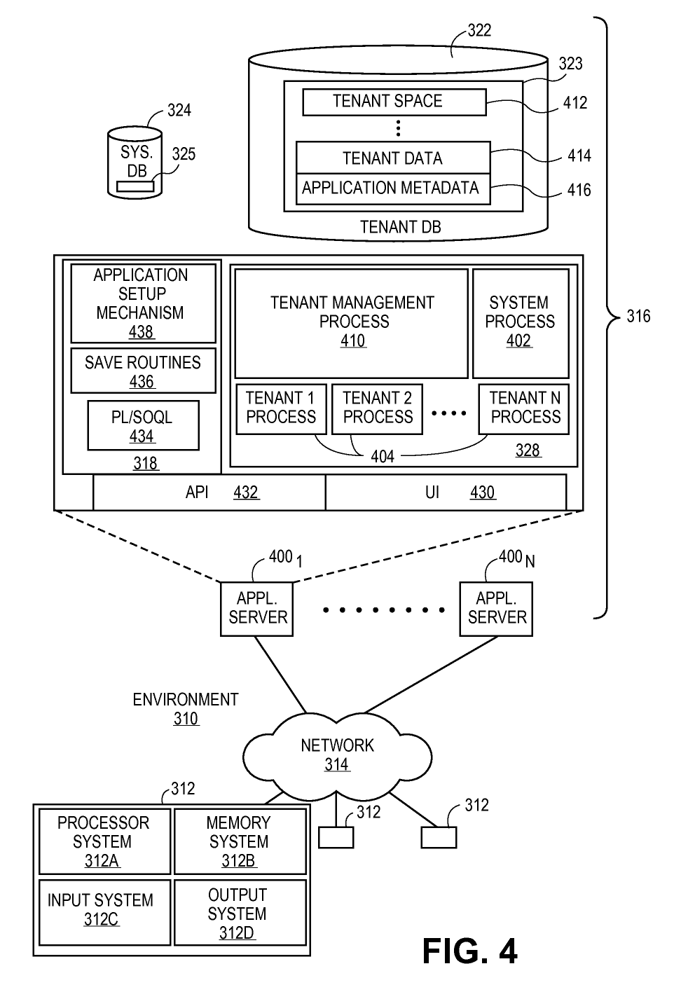

FIG. 4 also illustrates environment 310. However, in FIG. 4 elements of system 316 and various interconnections in an embodiment are further illustrated. FIG. 4 shows that user system 312 may include processor system 312A, memory system 312B, input system 312C, and output system 312D. FIG. 4 shows network 314 and system 316. FIG. 4 also shows that system 316 may include tenant data storage 322, tenant data 323, system data storage 324, system data 325, User Interface (UI) 430, Application Program Interface (API) 432, PL/SOQL 434, save routines 436, application setup mechanism 438, applications servers 400₁-400_{N}, system process space 402, tenant process spaces 404, tenant management process space 410, tenant storage area 412, user storage 414, and application metadata 416. In other embodiments, environment 310 may not have the same elements as those listed above and/or may have other elements instead of, or in addition to, those listed above.

User system 312, network 314, system 316, tenant data storage 322, and system data storage 324 were discussed above in FIG. 3. Regarding user system 312, processor system 312A may be any combination of one or more processors. Memory system 312B may be any combination of one or more memory devices, short term, and/or long term memory. Input system 312C may be any combination of input devices, such as one or more keyboards, mice, trackballs, scanners, cameras, and/or interfaces to networks. Output system 312D may be any combination of output devices, such as one or more monitors, printers, and/or interfaces to networks.

As shown by FIG. 4, system 316 may include a network interface 320 (of FIG. 3) implemented as a set of HTTP application servers 400, an application platform 318, tenant data storage 322, and system data storage 324. Also shown is system process space 402, including individual tenant process spaces 404 and a tenant management process space 410. Each application server 400 may be configured to tenant data storage 322 and the tenant data 323 therein, and system data storage 324 and the system data 325 therein to serve requests of user systems 312. The tenant data 323 might be divided into individual tenant storage areas 412, which can be either a physical arrangement and/or a logical arrangement of data.

Within each tenant storage area 412, user storage 414 and application metadata 416 might be similarly allocated for each user. For example, a copy of a user's most recently used (MRU) items might be stored to user storage 414. Similarly, a copy of MRU items for an entire organization that is a tenant might be stored to tenant storage area 412. A UI 430 provides a user interface and an API 432 provides an application programmer interface to system 316 resident processes to users and/or developers at user systems 312. The tenant data and the system data may be stored in various databases, such as one or more Oracle™ databases.

Application platform 318 includes an application setup mechanism 438 that supports application developers' creation and management of applications, which may be saved as metadata into tenant data storage 322 by save routines 436 for execution by subscribers as one or more tenant process spaces 404 managed by tenant management process 410 for example. Invocations to such applications may be coded using PL/SOQL 434 that provides a programming language style interface extension to API 432.

A detailed description of some PL/SOQL language embodiments is discussed in commonly owned co-pending U.S. Provisional Patent Application 40/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 416 for the subscriber making the invocation and executing the metadata as an application in a virtual machine.

Each application server 400 may be communicably coupled to database systems, e.g., having access to system data 325 and tenant data 323, via a different network connection. For example, one application server 400₁ might be coupled via the network 314 (e.g., the Internet), another application server 400_{N-1} might be coupled via a direct network link, and another application server 400_{N} might be coupled by yet a different network connection. Transfer Control Protocol and Internet Protocol (TCP/IP) are typical protocols for communicating between application servers 400 and the database system. However, it will be apparent to one skilled in the art that other transport protocols may be used to optimize the system depending on the network interconnect used.

In certain embodiments, each application server 400 is configured to handle requests for any user associated with any organization that is a tenant. Because it is desirable to be able to add and remove application servers from the server pool at any time for any reason, there is preferably no server affinity for a user and/or organization to a specific application server 400. In one embodiment, therefore, an interface system implementing a load balancing function (e.g., an F5 Big-IP load balancer) is communicably coupled between the application servers 400 and the user systems 312 to distribute requests to the application servers 400.

In one embodiment, the load balancer uses a least connections algorithm to route user requests to the application servers 400. Other examples of load balancing algorithms, such as round robin and observed response time, also can be used. For example, in certain embodiments, three consecutive requests from the same user could hit three different application servers 400, and three requests from different users could hit the same application server 400. In this manner, system 316 is multi-tenant, wherein system 316 handles storage of, and access to, different objects, data and applications across disparate users and organizations.

As an example of storage, one tenant might be a company that employs a sales force where each salesperson uses system 316 to manage their sales process. Thus, a user might maintain contact data, leads data, customer follow-up data, performance data, goals and progress data, etc., all applicable to that user's personal sales process (e.g., in tenant data storage 322). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 316 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 316 might also maintain system level data usable by multiple tenants or other data. Such system level data might include industry reports, news, postings, and the like that are sharable among tenants.

In certain embodiments, user systems 312 (which may be client systems) communicate with application servers 400 to request and update system-level and tenant-level data from system 316 that may require sending one or more queries to tenant data storage 322 and/or system data storage 324. System 316 (e.g., an application server 400 in system 316) automatically generates one or more SQL statements (e.g., one or more SQL queries) that are designed to access the desired information. System data storage 324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to the present invention. It should be understood that “table” and “object” may be used interchangeably herein. Each table generally contains one or more data categories logically arranged as columns or fields in a viewable schema. Each row or record of a table contains an instance of data for each category defined by the fields.

For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A method for collaboratively editing page content, the method comprising:
storing instances of classes in a central repository, wherein the classes correspond to components of a page;
providing concurrent user access to the classes;
updating the page in response to modifications to the page content made utilizing the one or more class instances.

2. The method of claim 1 wherein the one or more runtime pods operate within a multitenant database environment, wherein the multitenant database environment stores data for multiple client entities each identified by a tenant identifier (ID) having one of one or more users associated with the tenant ID, wherein users of each of multiple client entities can only access data identified by a tenant ID associated with the respective client entity, and wherein the multitenant database is a hosted database provided by an entity separate from the client entities, and provides on-demand database service to the client entities.

3. The method of claim 1 wherein the class instances comprise at least templates, events/actions, assets, and/or styles.

4. The method of claim 1 wherein, using the classes, a user may create, read, update or delete (CRUD) content items while another user may CRUD assets, styles, page templates or dynamic page elements that will be used to display the content according to page visual design standards.

5. The method of claim 1 further comprising:
dynamically assembling multiple elements as defined by the one or more classes; and
publishing the elements them as a dynamic, data-driven page within a web site.

6. The method of claim 1 further comprising visually binding data elements to corresponding page elements that define at least a portion of the page.

7. The method of claim 6 wherein the data elements comprise at least one query.

8. The method of claim 6 further comprising applying style elements to the data elements.

9. An article comprising a computer-readable medium having stored thereon instructions that, when executed by one or more processors, cause the one or more processors to:
store instances of classes in a central repository, wherein the classes correspond to components of a page;
provide concurrent user access to the classes;
update the page in response to modifications to the page content made utilizing the one or more class instances.

10. The article of claim 9 wherein the one or more runtime pods operate within a multitenant database environment, wherein the multitenant database environment stores data for multiple client entities each identified by a tenant identifier (ID) having one of one or more users associated with the tenant ID, wherein users of each of multiple client entities can only access data identified by a tenant ID associated with the respective client entity, and wherein the multitenant database is a hosted database provided by an entity separate from the client entities, and provides on-demand database service to the client entities.

11. The article of claim 9 wherein the class instances comprise at least templates, events/actions, assets, and/or styles.

12. The article of claim 9 wherein, using the classes, a user may create, read, update or delete (CRUD) content items while another user may CRUD assets, styles, page templates or dynamic page elements that will be used to display the content according to page visual design standards.

13. The article of claim 9 further comprising instructions that, when executed, cause the one or more processors to:
dynamically assemble multiple elements as defined by the one or more classes; and
publish the elements them as a dynamic, data-driven page within a web site.

14. The article of claim 9 further comprising instructions that, when executed, cause the one or more processors to visually bind data elements to corresponding page elements that define at least a portion of the page.

15. The article of claim 14 wherein the data elements comprise at least one query.

16. The article of claim 14 further comprising instructions that, when executed, cause the one or more processors to apply style elements to the data elements.

17. An apparatus for collaboratively editing page content, the apparatus comprising:
means for storing instances of classes in a central repository, wherein the classes correspond to components of a page;
means for providing concurrent user access to the classes;
means for updating the page in response to modifications to the page content made utilizing the one or more class instances.

18. The apparatus of claim 17 wherein the one or more runtime pods operate within a multitenant database environment, wherein the multitenant database environment stores data for multiple client entities each identified by a tenant identifier (ID) having one of one or more users associated with the tenant ID, wherein users of each of multiple client entities can only access data identified by a tenant ID associated with the respective client entity, and wherein the multitenant database is a hosted database provided by an entity separate from the client entities, and provides on-demand database service to the client entities.

19. The apparatus of claim 17 further comprising:
means for dynamically assembling multiple elements as defined by the one or more classes; and
means for publishing the elements them as a dynamic, data-driven page within a web site.

20. The apparatus of claim 17 further comprising means for visually binding data elements to corresponding page elements that define at least a portion of the page.

21. The apparatus of claim 20 further comprising means for applying style elements to the data elements.
